(19) United States
(12) Patent Application Publication
(10) Pub. No.: US 2015/0207425 A1
(43) Pub. Date: Jul. 23, 2015

(54) POWER CONVERSION DEVICE AND POWER CONVERSION METHOD

(71) Applicant: TOYOTA JIDOSHA KABUSHIKI KAISHA, Toyota-shi (JP)

(72) Inventor: Kazuyuki SASAKI, Nagoya-shi (JP)

(21) Appl. No.: 14/601,425

(22) Filed: Jan. 21, 2015

(30) Foreign Application Priority Data
Jan. 23, 2014 (JP) 2014-010796

(51) Int. Cl. H02M 3/335

(52) U.S. Cl. CPC H02M 3/33546

(57) ABSTRACT

A power conversion device includes primary and secondary full bridge circuits, and a control portion configured to adjust a phase difference between switching in the primary full bridge circuit and switching in the secondary full bridge circuit, so as to control power transmitted between the full bridge circuits, in which each of the full bridge circuits includes an upper arm and a lower arm connected in series to each other, the control portion shortens a dead time when neither of the upper and lower arms are turned on in a transmission state, and in a case where a gate driving state is detected in which both of the upper and lower arms are turned on, the control portion sets an adjustment value of the dead time in the transmission state to a dead time value greater than a dead time detection value when the gate driving state is detected.

### INCORPORATION BY REFERENCE

The disclosure of Japanese Patent Application No. 2014-010796 filed on Jan. 23, 2014 including the specification, drawings and abstract is incorporated herein by reference in its entirety.

### BACKGROUND OF THE INVENTION

1. Field of the Invention

The invention relates to a technique of converting power between a primary full bridge circuit and a secondary full bridge circuit.

2. Description of Related Art

There is a power conversion device which converts power between a primary full bridge circuit and a secondary full bridge circuit (for example, refer to Japanese Patent Application Publication No. 2011-193713 (JP 2011-193713 A)). Each of the primary full bridge circuit and the secondary full bridge circuit includes an upper arm, and a lower arm connected in series to the upper arm.

However, if characteristics (for example, electrical characteristics such as current characteristics) of each arm vary, a period (dead time) fluctuates in, which neither of the upper arm and the lower arm are turned on. If the dead time is too long, a loss may increase and thus power conversion efficiency may be reduced. Conversely, if the dead time is too short, the upper arm and the lower arm may be damaged by a through-current.

### SUMMARY OF THE INVENTION

Therefore, an object of the invention is to provide a power conversion device and a power conversion method, capable of preventing a reduction in power conversion efficiency and damages by a through-current.

According to an aspect, there is provided a power conversion device including a primary full bridge circuit; a secondary full bridge circuit; and a control portion configured to adjust a phase difference between switching in the primary full bridge circuit and switching in the secondary full bridge circuit, so as to control transmission power transmitted between the primary full bridge circuit and the secondary full bridge circuit, in which each of the primary full bridge circuit and the secondary full bridge circuit includes an upper arm and a lower arm connected in series to the upper arm, the control portion shortens a dead time when neither of the upper arm and the lower arm are turned on in a transmission state in which the transmission power is transmitted with a predetermined power value, and in a case where a gate driving state is detected in which both of the upper arm and the lower arm are turned on, the control portion sets an adjustment value of the dead time in the transmission state to a dead time value which is greater than a dead time detection value when the gate driving state is detected.

According to the aspect, it is possible to prevent a reduction in power conversion efficiency and damages by a through-current.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a diagram illustrating a configuration example of a power conversion device;

FIG. 2 is a block diagram illustrating a configuration example of a controller;

FIG. 3 is a timing chart illustrating a switching example of a primary circuit and a second circuit;

FIG. 4 is a timing chart illustrating an example of a dead time;

FIG. 5 is a configuration diagram illustrating an example of the controller;

FIG. 6 is a flowchart illustrating an example of a power conversion method;

FIG. 7 is a flowchart illustrating an example of a power conversion method; and

FIG. 8 is a flowchart illustrating an example of a power conversion method.

### DETAILED DESCRIPTION OF EMBODIMENTS

<Configuration of Power Supply Device 101>

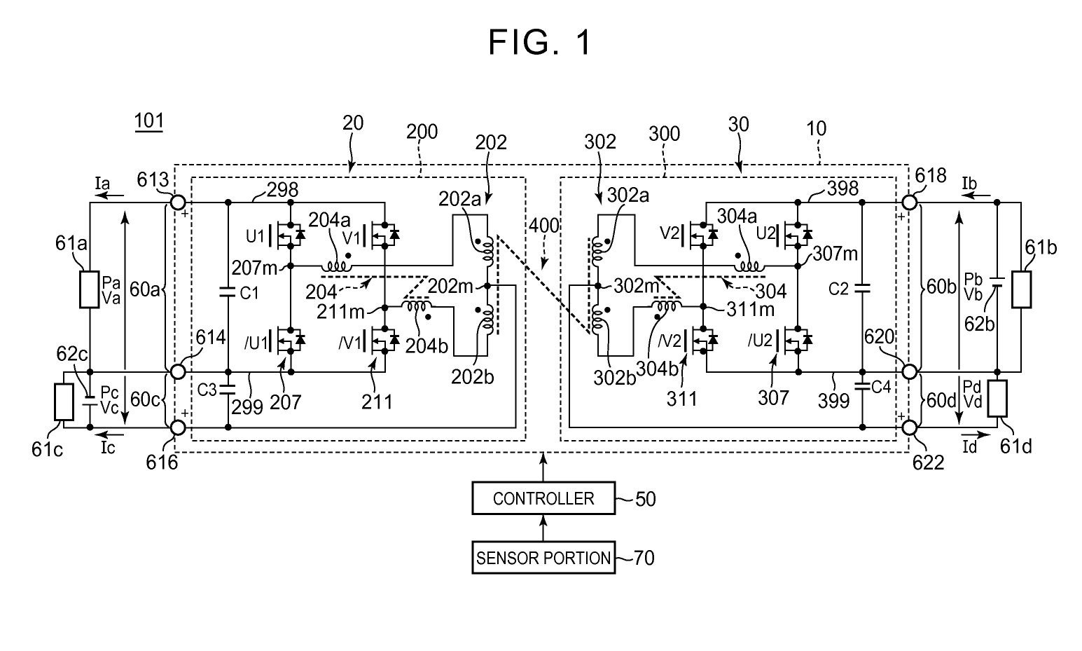

FIG. 1 is a block diagram illustrating a configuration example of a power supply device 101 which is an embodiment of a power conversion device. The power supply device 101 is a power supply system which includes, for example, a power supply circuit 10, a controller 50, and a sensor portion 70. The power supply device 101 is a system which is mounted in, for example, a vehicle such as an automobile and supplies power to each in-vehicle load. Specific examples of such a vehicle may include a hybrid vehicle, a plug-in hybrid vehicle, and an electric vehicle. The power supply device 101 may be mounted in a vehicle which uses an engine as a main driving source.

The power supply device 101 has, as primary ports, for example, a first input/output port 60a which is connected to a primary high voltage system load 61a and a second input/output port 60c which is connected to a primary low voltage system load 61c and a primary low voltage system power supply 62c. The primary low voltage system power supply 62c supplies power to the primary low voltage system load 61c which operates with the same voltage system (for example, a 12 V system) as the primary low voltage system power supply 62c. The primary low voltage system power supply 62c supplies power which is stepped up by the primary conversion circuit 20 of the power supply circuit 10, to the primary high voltage system load 61a which operates with a voltage system (for example, a 48 V system higher than the 12 V system) different from that of the primary low voltage system power supply 62c. Specific examples of the primary low voltage system power supply 62c may include a secondary battery such as a lead battery.

The power supply device 101 has, secondary ports, for example, a third input/output port 60b which is connected to a secondary high voltage system load 61b and a second high voltage system power supply 62b, and a fourth input/output port 60d which is connected to a secondary low voltage system load 61d. The second high voltage system power supply 62b supplies power to the secondary high voltage system load 61b which operates with the same voltage system (for example, a 288 V system higher than the 12 V system and the 48 V system) as the second high voltage system power supply 62b. The second high voltage system power supply 62b supplies power which is stepped down by the secondary conversion circuit 30 of the power supply circuit 10, to the secondary low voltage system load 61d which operates with a voltage system (for example, a 72 V system lower than the 288 V system) different from that of the second high voltage system power supply 62b. Specific examples of the second high voltage system power supply 62b may include a secondary battery such as a lithium ion battery.

The power supply circuit 10 is a power conversion circuit which has the above-described four input/output ports and has a function of performing power conversion between arbitrary two input/output ports which are selected from among the four input/output ports. The power supply device 101 provided with the power supply circuit 10 may be a device which has a plurality of (three or more) input/output ports and can perform power conversion between arbitrary two ports among the plurality of (three or more) input/output ports. For example, the power supply circuit 10 may be a circuit which has three input/output ports without the fourth input/output port 60d.

Port power items Pa, Pc, Pb and Pd are respectively input/output power items (input power items or output power items) at the first input/output port 60a, the second input/output port 60c, the third input/output port 60b, and the fourth input/output port 60d. Port voltages Va, Vc, Vb and Vd are respectively input/output voltages (input voltages or output voltages) at the first input/output port 60a, the second input/output port 60c, the third input/output port 60b, and the fourth input/output port 60d. Port currents Ia, Ic, Ib and Id are respectively input/output currents (input currents or output currents) at the first input/output port 60a, the second input/output port 60c, the third input/output port 60b, and the fourth input/output port 60d.

The power supply circuit 10 includes a capacitor C1 provided at the first input/output port 60a, a capacitor C3 provided at the second input/output port 60c, a capacitor C2 provided at the third input/output port 60b, and a capacitor C4 provided at the fourth input/output port 60d. Specific examples of the capacitors C1, C2, C3 and C4 may include film capacitors, aluminum electrolytic capacitors, ceramic capacitors, and solid polymer capacitors.

The capacitor C1 is inserted between a high potential side terminal 613 of the first input/output port 60a and a low potential side terminal 614 of the first input/output port 60a and the second input/output port 60c. The capacitor C3 is inserted between a high potential side terminal 616 of the second input/output port 60c and the low potential side terminal 614 of the first input/output port 60a and the second input/output port 60c. The capacitor C2 is inserted between a high potential side terminal 618 of the third input/output port 60b and a low potential side terminal 620 of the third input/output port 60b and the fourth input/output port 60d. The capacitor C4 is inserted between a high potential side terminal 622 of the fourth input/output port 60d and the low potential side terminal 620 of the third input/output port 60b and the fourth input/output port 60d.

The capacitors C1, C2, C3 and C4 may be provided inside the power supply circuit 10, and may be provided outside the power supply circuit 10.

The power supply circuit 10 is a power conversion circuit which includes the primary conversion circuit 20 and the secondary conversion circuit 30. The primary conversion circuit 20 and the secondary conversion circuit 30 are connected to each other via a primary magnetic coupling reactor 204 and a secondary magnetic coupling reactor 304, and is also magnetically coupled to a transformer 400 (a center tap type transformer). The primary ports including the first input/output port 60a and the second input/output port 60c are connected to the secondary ports including the third input/output port 60b and the fourth input/output port 60d via the transformer 400.

The primary conversion circuit 20 is a primary circuit which includes a primary full bridge circuit 200, the first input/output port 60a, and the second input/output port 60c. The primary full bridge circuit 200 is a primary power conversion portion which includes a primary coil 202 of the transformer 400, the primary magnetic coupling reactor 204, a primary first upper arm U1, a primary first lower arm /U1, a primary second upper arm V1, and a primary second lower arm /V1. Here, each of the primary first upper arm U1, the primary first lower arm /U1, the primary second upper arm V1, and the primary second lower arm /V1 is a switching element which is constituted by, for example, an N channel type MOSFET and a body diode which is a parasitic element of the MOSFET. A diode may be additionally connected in parallel to the MOSFET.

The primary full bridge circuit 200 has a primary positive bus bar 298 which is connected to the high potential side terminal 613 of the first input/output port 60a, and a primary negative bus bar 299 which is connected to the low potential side terminal 614 of the first input/output port 60a and the second input/output port 60c.

A primary first arm circuit 207 in which the primary first upper arm U1 and the primary first lower arm /U1 are connected in series to each other is provided between the primary positive bus bar 298 and the primary negative bus bar 299. The primary first arm circuit 207 is a primary first power conversion circuit portion (primary U phase power conversion circuit portion) which can perform a power conversion operation through a switching operation between turning-on and turning-off of the primary first upper arm U1 and the primary first lower arm /U1. In addition, a primary second arm circuit 211 in which the primary second upper arm V1 is connected in series to the primary second lower arm /V1 is provided in parallel to the primary first arm circuit 207 between the primary positive bus bar 298 and the primary negative bus bar 299. The primary second arm circuit 211 is a primary second power conversion circuit portion (primary V phase power conversion circuit portion) which can perform a power conversion operation through a switching operation between turning-on and turning-off of the primary second upper arm V1 and the primary second lower arm /V1.

The primary coil 202 and the primary magnetic coupling reactor 204 are provided in a bridge part which connects a midpoint 207m of the primary first arm circuit 207 to a midpoint 211m of the primary second arm circuit 211. More specifically, in relation to a connection relationship of the bridge part, the midpoint 207m of the primary first arm circuit 207 is connected to one end of a primary first reactor 204a of the primary magnetic coupling reactor 204. The other end of the primary first reactor 204a is connected to one end of the primary coil 202. The other end of the primary coil 202 is connected to one end of a primary second reactor 204b of the primary magnetic coupling reactor 204. The other end of the primary second reactor 204b is connected to the midpoint 211m of the primary second arm circuit 211. The primary magnetic coupling reactor 204 includes the primary first reactor 204a, and the primary second reactor 204b which is magnetically coupled to the primary first reactor 204a with a coupling coefficient k₁.

The midpoint 207m is a primary first intermediate node between the primary first upper arm U1 and the primary first lower arm /U1, and the midpoint 211m is a primary second intermediate node between the primary second upper arm V1 and the primary second lower arm /V1.

The first input/output port 60a is a port which is provided between the primary positive bus bar 298 and the primary negative bus bar 299. The first input/output port 60a includes the terminal 613 and the terminal 614. The second input/output port 60c is a port which is provided between the primary negative bus bar 299 and a center tap 202m of the primary coil 202. The second input/output port 60c includes the terminal 614 and the terminal 616.

The center tap 202m is connected to the high potential side terminal 616 of the second input/output port 60c. The center tap 202m is an intermediate connection point between a primary first winding 202a and a primary second winding 202b formed in the primary coil 202.

The secondary conversion circuit 30 is a secondary circuit which includes a secondary full bridge circuit 300, the third input/output port 60b, and the fourth input/output port 60d. The secondary full bridge circuit 300 is a secondary power conversion portion which includes a secondary coil 302 of the transformer 400, the secondary magnetic coupling reactor 304, a secondary first upper arm U2, a secondary first lower arm /U2, a secondary second upper arm V2, and a secondary second lower arm /V2. Here, each of the secondary first upper arm U2, the secondary first lower arm /U2, the secondary second upper aim V2, and the secondary second lower arm /V2 is a switching element which is constituted by, for example, an N channel type MOSFET and a body diode which is a parasitic element of the MOSFET. A diode may be additionally connected in parallel to the MOSFET.

The secondary full bridge circuit 300 has a secondary positive bus bar 398 which is connected to the high potential side terminal 618 of the third input/output port 60b, and a secondary negative bus bar 399 which is connected to the low potential side terminal 620 of the third input/output port 60b and the fourth input/output port 60d.

A secondary first arm circuit 307 in which the secondary first upper arm U2 is connected in series to the secondary first lower arm /U2 is provided between the secondary positive bus bar 398 and the secondary negative bus bar 399. The secondary first arm circuit 307 is a secondary first power conversion circuit portion (secondary U phase power conversion circuit portion) which can perform a power conversion operation through a switching operation between turning-on and turning-off of the secondary first upper arm U2 and the secondary first lower arm /U2. In addition, a secondary second arm circuit 311 in which the secondary second upper arm V2 is connected in series to the secondary second lower arm /V2 is provided in parallel to the secondary first arm circuit 307 between the secondary positive bus bar 398 and the secondary negative bus bar 399. The secondary second arm circuit 311 is a secondary second power conversion circuit portion (secondary V phase power conversion circuit portion) which can perform a power conversion operation through a switching operation between turning-on and turning-off of the secondary second upper arm V2 and the secondary second lower arm /V2.

The secondary coil 302 and the secondary magnetic coupling reactor 304 are provided in a bridge part which connects a midpoint 307m of the secondary first arm circuit 307 to a midpoint 311m of the secondary second arm circuit 311. More specifically, in relation to a connection relationship of the bridge part, the midpoint 307m of the secondary first arm circuit 307 is connected to one end of a secondary first reactor 304a of the secondary magnetic coupling reactor 304. The other end of the secondary first reactor 304a is connected to one end of the secondary coil 302. The other end of the secondary coil 302 is connected to one end of a secondary second reactor 304b of the secondary magnetic coupling reactor 304. The other end of the secondary second reactor 304b is connected to the midpoint 311m of the secondary second arm circuit 311. The secondary magnetic coupling reactor 304 includes the secondary first reactor 304a, and the secondary second reactor 304b which is magnetically coupled to the secondary first reactor 304a with a coupling coefficient k₂.

The midpoint 307m is a secondary first intermediate node between the secondary first upper arm U2 and the secondary first lower arm /U2, and the midpoint 311m is a secondary second intermediate node between the secondary second upper arm V2 and the secondary second lower arm /V2.

The third input/output port 60b is a port which is provided between the secondary positive bus bar 398 and the secondary negative bus bar 399. The third input/output port 60b includes the terminal 618 and the terminal 620. The fourth input/output port 60d is a port which is provided between the secondary negative bus bar 399 and a center tap 302m of the secondary coil 302. The fourth input/output port 60d includes the terminal 620 and the terminal 622.

The center tap 302m is connected to the high potential side terminal 622 of the fourth input/output port 60d. The center tap 302m is an intermediate connection point between a secondary first winding 302a and a secondary second winding 302b formed in the secondary coil 302.

In FIG. 1, the power supply device 101 includes the sensor portion 70. The sensor portion 70 is detection means for detecting an input/output value Y in at least one of the first to fourth input/output ports 60a, 60c, 60b and 60d in a predetermined detection cycle, and for outputting a detected value Yd corresponding to the detected input/output value Y to the controller 50. The detected value Yd may be a detected voltage obtained by detecting an input/output voltage, may be a detected current obtained by detecting an input/output current, and may be detected power obtained by detecting input/output power. The sensor portion 70 may be provided inside the power supply circuit 10, and may be provided outside the power supply circuit 10.

The sensor portion 70 includes, for example, a voltage detection section which detects an input/output voltage which is generated in at least one of the first to fourth input/output ports 60a, 60c, 60b and 60d. The sensor portion 70 includes, for example, a primary voltage detection section which outputs at least one detected value of the input/output voltage Va and the input/output voltage Vc as a primary voltage detection value, and a secondary voltage detection section which outputs at least one detected value of the input/output voltage Vb and the input/output voltage Vd as a secondary voltage detection value.

The voltage detection section of the sensor portion 70 has, for example, a voltage sensor which monitors an input/output voltage value of at least one port, and a voltage detection circuit which output a detected value corresponding to the input/output voltage value monitored by the voltage sensor to the controller 50.

The sensor portion 70 includes a current detection section which detects an input/output current which flows through at least one of the first to fourth input/output ports 60a, 60c, 60b and 60d. The sensor portion 70 includes, for example, a primary current detection section which outputs at least one detected current of the input/output current Ia and the input/output current Ic as a primary current detection value, and a secondary current detection section which outputs at least one detected current of the input/output current Ib and the input/output current Id as a secondary current detection value.

The current detection section of the sensor portion 70 has, for example, a current sensor which monitors an input/output current value of at least one part, and a current detection circuit which outputs a detected current corresponding to the input/output current value monitored by the current sensor to the controller 50.

The power supply device 101 includes the controller 50. The controller 50 is, for example, an electronic circuit provided with a microcomputer into which a CPU is built. The controller 50 may be provided inside the power supply circuit 10, and may be provided outside the power supply circuit 10.

The controller 50 feedback-controls a power conversion operation of the power supply circuit 10 so that the detected value Yd of the input/output value Y in at least one of the first to fourth input/output ports 60a, 60c, 60b and 60d converges on an aimed value Yo which is set to the corresponding port. The aimed value Yo is a command value which is set by the controller 50 or predetermined devices other than the controller 50, on the basis of driving conditions defined for each load (for example, the primary low voltage system load 61c) connected to each input/output port. The aimed value Yo functions as an output aimed value when power is output from the port, and functions as an input aimed value when power is input to the port. The aimed value Yo may be an aimed voltage value, may be an aimed current value, and may be an aimed power value.

The controller 50 feedback-controls the power conversion operation of the power supply circuit 10 so that transmission power P which is transmitted between the primary conversion circuit 20 and the secondary conversion circuit 30 via the transformer 400 converges on aimed transmission power Po which is set. The transmission power is also referred to as a power transmission amount. The aimed transmission power is also referred to as command transmission power.

The controller 50 feedback-controls the power conversion operation performed by the power supply circuit 10 by changing values of predetermined control parameters X, and can thus adjust the input/output value Y in each of the first to fourth input/output ports 60a, 60c, 60b and 60d of the power supply circuit 10. As the main control parameters X, two control variables including a phase difference φ and a duty ratio D (ON time δ) may be used.

The phase difference φ is a switching time deviation (time lag) between the power conversion circuit portions which are in phase, of the primary full bridge circuit 200 and the secondary full bridge circuit 300. The duty ratio D (ON time δ) is a duty ratio (ON time) of a switching waveform in each power conversion circuit portion formed in the primary full bridge circuit 200 and the secondary full bridge circuit 300.

The two control parameters X can be controlled separately from each other. The controller 50 changes the input/output value Y in each input/output port of the power supply circuit 10 through duty ratio control and/or phase control of the primary full bridge circuit 200 and the secondary full bridge circuit 300, using the phase difference φ and the duty ratio D (ON time δ).

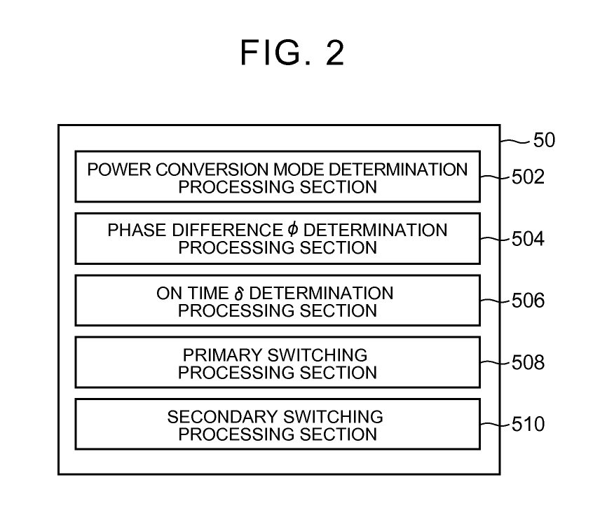

FIG. 2 is a block diagram of the controller 50. The controller 50 is a control portion which has a function of performing switching control of each switching element such as the primary first upper arm U1 of the primary conversion circuit 20 and each switching element such as the secondary first upper arm U2 of the secondary conversion circuit 30. The controller 50 includes a power conversion mode determination processing section 502, a phase difference φ determination processing section 504, an ON time δ determination processing section 506, a primary switching processing section 508, and a secondary switching processing section 510. The controller 50 is, for example, an electronic circuit provided with a microcomputer into which a CPU is built.

The power conversion mode determination processing section 502 selects and determines an operation mode from among power conversion modes A to L, which will be described below, of the power supply circuit 10, for example, on the basis of a predetermined external signal (for example, a signal indicating a difference between the detected value Yd and the aimed value Yo in a certain port). The power conversion mode includes a mode A in which power input from the first input/output port 60a is converted and output to the second input/output port 60c, a mode B in which power input from the first input/output port 60a is converted and output to the third input/output port 60b, and a mode C in which power input from the first input/output port 60a is converted and output to the fourth input/output port 60d.

The power conversion mode also includes a mode D in which power input from the second input/output port 60c is converted and output to the first input/output port 60a, a mode E in which power input from the second input/output port 60c is converted and output to the third input/output port 60b, and a mode F in which power input from the second input/output port 60c is converted and output to the fourth input/output port 60d.

The power conversion mode also includes a mode G in which power input from the third input/output port 60b is converted and output to the first input/output port 60a, a mode H in which power input from the third input/output port 60b is converted and output to the second input/output port 60c, and a mode I in which power input from the third input/output port 60b is converted and output to the fourth input/output port 60d.

The power conversion mode also includes a mode J in which power input from the fourth input/output port 60d is converted and output to the first input/output port 60a, a mode K in which power input from the fourth input/output port 60d is converted and output to the second input/output port 60c, and a mode L in which power input from the fourth input/output port 60d is converted and output to the third input/output port 60b.

The phase difference φ determination processing section 504 has a function of setting a phase difference φ in a switching cycle between the switching elements of the primary conversion circuit 20 and the secondary conversion circuit 30 in order to cause the power supply circuit 10 to function as a DC-DC converter circuit.

The ON time δ determination processing section 506 has a function of setting an ON time δ of each switching element of the primary conversion circuit 20 and the secondary conversion circuit 30 in order to cause the primary conversion circuit 20 and the secondary conversion circuit 30 to function as a step-up circuit and a step-down circuit, respectively.

The primary switching processing section 508 has a function of controlling switching of each switching element in the primary first upper arm U1, the primary first lower arm /U1, the primary second upper arm V1, and the primary second lower arm /V1 on the basis of outputs from the power conversion mode determination processing section 502, the phase difference φ determination processing section 504, and the ON time δ determination processing section 506.

The secondary switching processing section 510 has a function of controlling switching of each switching element in the secondary first upper arm U2, the secondary first lower arm /U2, the secondary second upper arm V2, and the secondary second lower arm /V2 on the basis of outputs from the power conversion mode determination processing section 502, the phase difference φ determination processing section 504, and the ON time δ determination processing section 506.

<Operation of Power Supply Device 101>

An operation of the power supply device 101 will be described with reference to FIGS. 1 and 2. For example, when an external signal requesting the power supply circuit 10 to operate in the power conversion mode of the mode F is input, the power conversion mode determination processing section 502 of the control circuit 50 determines the mode F as the power conversion mode of the power supply circuit 10. In this mode, a voltage input to the second input/output port 60c is stepped up by a step-up function of the primary conversion circuit 20. The stepped-up voltage is transmitted to the third input/output port 60b side by the power supply circuit 10 functioning as the DC-DC converter circuit, and is stepped down by a step-down function of the secondary power conversion circuit 30. Then, the stepped-down voltage is output from the fourth input/output port 60d.

Now, the step-up and step-down functions of the primary conversion circuit 20 will be described in detail. Referring to the second input/output port 60c and the first input/output port 60a, the terminal 616 of the second input/output port 60c is connected to the midpoint 207m of the primary first arm circuit 207 via the primary first winding 202a and the primary first reactor 204a connected in series to the primary first winding 202a. Then, both ends of the primary first arm circuit 207 are connected to the first input/output port 60a, and thus a step-up/step-down circuit is provided between the terminal 616 of the second input/output port 60c and the first input/output port 60a.

The terminal 616 of the second input/output port 60c is connected to the midpoint 211m of the primary second arm circuit 211 via the primary second winding 202b and the primary second reactor 204b connected in series to the primary second winding 202b. Then, both ends of the primary second arm circuit 211 are connected to the first input/output port 60a, and thus the step-up/step-down circuit is connected in parallel between the terminal 616 of the second input/output port 60c and the first input/output port 60a. Since the secondary conversion circuit 30 has substantially the same configuration as that of the primary conversion circuit 20, two step-up/step-down circuits are connected in parallel between the terminal 622 of the fourth input/output port 60d and the third input/output port 60b. Thus, the secondary conversion circuit 30 has the step-up and step-down functions in the same manner as the primary conversion circuit 20.

Next, the function of the power supply circuit 10 as the DC-DC converter circuit will be described in detail. Referring to the first input/output port 60a and the third input/output port 60b, the primary full bridge circuit 200 is connected to the first input/output port 60a, and the secondary full bridge circuit 300 is connected to the third input/output port 60b. The primary coil 202 provided in the bridge part of the primary full bridge circuit 200 and the secondary coil 302 provided in the bridge part of the secondary full bridge circuit 300 are magnetically coupled to each other with a coupling coefficient k_{T}, and thus the transformer 400 functions as a center tap type transformer having a turn ratio of 1:N. Therefore, the phase difference φ in a switching cycle between the switching elements of the primary full bridge circuit 200 and the secondary full bridge circuit 300 is adjusted so that power input to the first input/output port 60a is converted and transmitted to the third input/output port 60b, or power input to the third output input/port 60b is converted and transmitted to the first input/output port 60a.

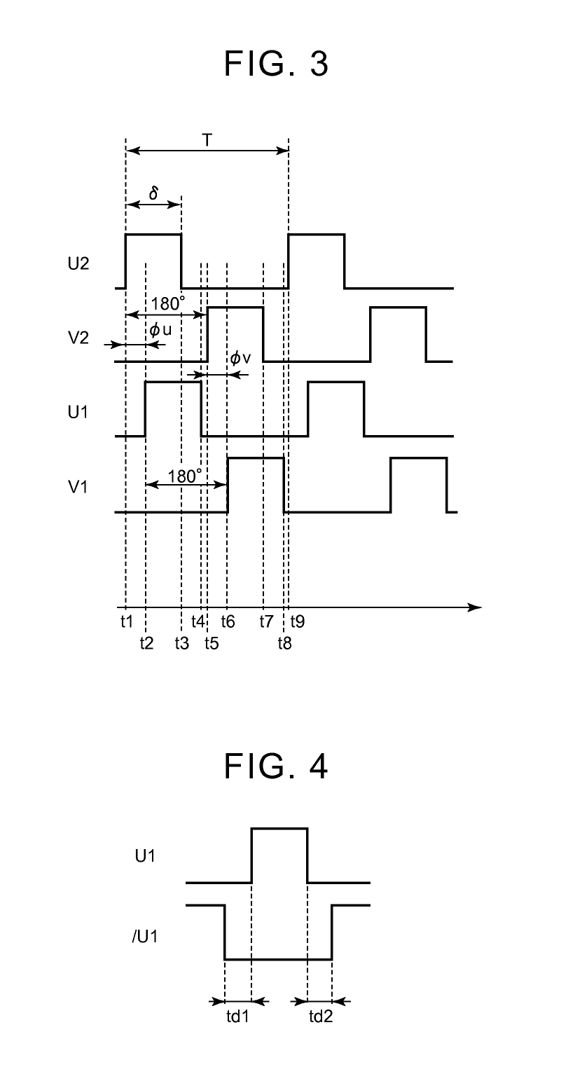

FIG. 3 is a diagram illustrating a timing chart of a switching waveform of turning-on and turning-off of each arm formed in the power supply circuit 10 under the control of the controller 50. In FIG. 3, U1 indicates a turning-on and turning-off waveform of the primary first upper arm U1, V1 indicates a turning-on and turning-off waveform of the primary second upper arm V1, U2 indicates a turning-on and turning-off waveform of the secondary first upper arm U2, and V2 indicates a turning-on and turning-off waveform of the secondary second upper arm V2. Turning-on and turning-off waveforms of the primary first lower arm /U1, the primary second lower arm /V1, the secondary first lower arm /U2, and the secondary second lower arm /V2 are waveforms (not illustrated) obtained by respectively inverting the turning-on and turning-off waveforms of the primary first upper arm U1, the primary second upper arm V1, the secondary first upper arm U2, and the secondary second upper arm V2. The dead time may be provided between both of the turning-on and turning-off waveforms of the upper and lower arms so that both of the upper and lower arms are turned on and thus a through-current does not flow therethrough. In FIG. 3, a high level indicates an ON state, and a low level indicates an OFF state.

Here, a step-up or step-down ratio in the primary conversion circuit 20 and the secondary conversion circuit 30 can be changed by changing the ON time δ for each of U1, V1, U2, and V2. For example, if the ON times δ of U1, V1, U2, and V2 are made the same as each other, a step-up or step-down ratio of the primary conversion circuit 20 can be made the same as a step-up or step-down ratio of the secondary conversion circuit 30.

The ON time δ determination processing section 506 makes the ON times δ of U1, V1, U2, and V2 the same as each other so that step-up or step-down ratios of the primary conversion circuit 20 and the secondary conversion circuit 30 are the same as each other (each ON time δ=primary ON time δ11=secondary ON time δ12=time value α).

The step-up or step-down ratio of the primary conversion circuit 20 is defined by the duty ratio D which is a ratio of the ON time δ which occupies a switching cycle T of the switching element (arm) formed in the primary full bridge circuit 200. Similarly, the step-up or step-down ratio of the secondary conversion circuit 30 is defined by the duty ratio D which is a ratio of the ON time δ which occupies a switching cycle T of the switching element (arm) formed in the secondary full bridge circuit 300. The step-up or step-down ratio of the primary conversion circuit 20 is a transformation ratio between the first input/output port 60a and the second input/output port 60c, and the step-up or step-down ratio of the secondary conversion circuit 30 is a transformation ratio between the third input/output port 60b and the fourth input/output port 60d.

Therefore, for example, the step-up or step-down ratio of the primary conversion circuit 20 is represented by a voltage of the second input/output port 60c/a voltage of the first input/output port 60a=δ11/T=α/T, and step-up or step-down ratio of the secondary conversion circuit 30 is represented by a voltage of the fourth input/output port 60d/a voltage of the third input/output port 60b=δ12/T=α/T. In other words, the step-up or step-down ratios of the primary conversion circuit 20 and the secondary conversion circuit 30 have the same value (=α/T).

The ON time δ of FIG. 3 indicates the ON time δ11 of the primary first upper arm U1 and the primary second upper arm V1, and also indicates the ON time δ12 of the secondary first upper arm U2 and the secondary second upper arm V2. The switching cycle T of the arms formed in the primary full bridge circuit 200 and the switching cycle T of the arms formed in the secondary full bridge circuit 300 are the same period of time.

A phase difference between U1 and V1 is 180 degrees (π), and a phase difference between U2 and V2 is 180 degrees (π). The phase difference between U1 and V1 is a time difference between the time point t2 and the time point t6, and the phase difference between U2 and V2 is a time difference between the t1 and the time point t5.

The transmission power P transmitted between the primary conversion circuit 20 and the secondary conversion circuit 30 can be adjusted by changing at least one of a phase difference φu between U1 and U2 and a phase difference φv between V1 and V2. The phase difference φu is a time difference between the time point t1 and the time point t2, and the phase difference φv is a time difference between the time point t5 and the time point t6.

If the phase difference φu>0, or the phase difference φv>0, the transmission power P can be transmitted from the primary conversion circuit 20 to the secondary conversion circuit 30. If the phase difference φu<0, or the phase difference φv<0, the transmission power P can be transmitted from the secondary conversion circuit 30 to the primary conversion circuit 20. In other words, in the power conversion circuit portions which are in phase, of the primary full bridge circuit 200 and the secondary full bridge circuit 300, the transmission power P is transmitted from the full bridge circuit having the power conversion circuit portion in which the upper arm is turned on earlier to the full bridge circuit having the power conversion circuit portion in which the upper arm is turned on later.

For example, in a case of FIG. 3, the turned-on time point t1 of the secondary first upper arm U2 is earlier than the turned-on time point t2 of the primary first upper arm U1. Therefore, the transmission power P is transmitted from the secondary full bridge circuit 300 provided with the secondary first arm circuit 307 having the secondary first upper arm U2 to the primary full bridge circuit 200 provided with the primary first arm circuit 207 having the primary first upper arm U1. Similarly, the turned-on time point t5 of the secondary second upper arm V2 is earlier than the turned-on time point t6 of the primary second upper arm V1. Therefore, the transmission power P is transmitted from the secondary full bridge circuit 300 provided with the secondary second am circuit 311 having the secondary second upper arm V2 to the primary full bridge circuit 200 provided with the primary second arm circuit 211 having the primary second upper arm V1.

The phase difference φ is a switching time deviation (time lag) between the power conversion circuit portions which are in phase, of the primary full bridge circuit 200 and the secondary full bridge circuit 300. For example, the phase difference φu is a switching timing deviation between corresponding phases of the primary first arm circuit 207 and the secondary first arm circuit 307, and the phase difference φv is a switching timing deviation between corresponding phases of the primary second arm circuit 211 and the secondary second arm circuit 311.

The controller 50 performs control in a state in which the phase difference φu and the phase difference φv are the same as each other, but may perform control in a state in which the phase difference φu and the phase difference φv are deviated relative to each other in a range in which accuracy required in the transmission power P is satisfied. In other words, the phase difference φu and the phase difference φv are typically controlled to be the same value, but may be controlled to be different values if accuracy required in the transmission power P is satisfied.

Thus, for example, when an external signal requesting the power supply circuit 10 to operate in the power conversion mode of the mode F is input, the power conversion mode determination processing section 502 determines to select the mode F. The ON time δ determination processing section 506 sets the ON time δ which defines a step-up ratio used for allowing the primary conversion circuit 20 to function as a step-up circuit in which a voltage input to the second input/output port 60c is stepped up and output to the first input/output port 60a. The secondary conversion circuit 30 is caused to function as the step-down circuit in which a voltage input to the third input/output port 60b is stepped down at the step-down ratio defined by the ON time δ which is set by the ON time δ determination processing section 506, and output to the fourth input/output port 60d. The phase difference φ determination processing section 504 sets a phase difference φ suitable for transmitting the power input to the first input/output port 60a to the third input/output port 60b in a desired power transmission amount P.

The primary switching processing section 508 controls switching of each switching element of the primary first upper arm U1, the primary first lower arm /U1, the primary second upper arm V1, and the primary second lower arm /V1 so that the primary conversion circuit 20 is caused to function as both the step-up circuit and part of the DC-DC converter circuit.

The secondary switching processing section 510 controls switching of each switching element of the secondary first upper arm U2, the secondary first lower arm /U2, the secondary second upper arm V2, and the secondary second lower arm /V2 so that the second conversion circuit 30 is caused to function as both the step-down circuit and part of the DC-DC converter circuit.

As described above, the primary conversion circuit 20 and the secondary conversion circuit 30 can be operated to function as the step-up circuit or the step-down circuit, and the power supply circuit 10 can be operated to function as a two-way DC-DC converter circuit. Therefore, power conversion in all of the power conversion modes A to L can be performed, in other words, power can be converted between two input/output ports selected from among the four input/output ports.

The transmission power P (also referred to as the power transmission amount P) which is adjusted according to the phase difference φ by the controller 50 is power which is sent from one conversion circuit to the other conversion circuit in the primary conversion circuit 20 and the secondary conversion circuit 30 via the transformer 400, and is expressed by

P=(N×Va×Vb)/(π×ω×L)×F(D,φ) Equation (1).

Here, N indicates a turn ratio of the transformer 400, Va indicates an input/output voltage of the first input/output port 60a, and Vb indicates an input/output voltage of the third input/output port 60b. π indicates a circular constant, and ω (×2π×f=2π/T) indicates a switching angular frequency of the primary conversion circuit 20 and the secondary conversion circuit 30. In addition, f indicates a switching frequency of the primary conversion circuit 20 and the secondary conversion circuit 30, T indicates a switching cycle of the primary conversion circuit 20 and the secondary conversion circuit 30, and L indicates equivalent inductance related to power transmission of the magnetic coupling reactors 204 and 304 and the transformer 400. F(D,φ) indicates a function which has the duty ratio D and the phase difference φ as variables, and is a variable which monotonously increases according to an increase in the phase difference φ regardless of the duty ratio D. The duty ratio D and the phase difference φ are control parameters which are designed to change in a range between predetermined upper and lower limit values.

The controller 50 adjusts the transmission power P by changing the phase difference φ so that a port voltage Vp in at least one predetermined port among the primary ports and the secondary ports converges on an aimed port voltage Vo. Thus, even if current consumption of a load connected to the predetermined port increases, the controller 50 adjusts the transmission power P by changing the phase difference φ, and thus it is possible to prevent the port voltage Vp from being lower than the aimed port voltage Vo.

For example, the controller 50 adjusts the transmission power P by changing the phase difference φ so that the port voltage Vp in the other port which is a transmission destination of the transmission power P among the primary ports and the secondary ports converges on the aimed port voltage Vo. Thus, even if current consumption of a load connected to the port which is the transmission destination of the transmission power P increases, the controller 50 adjusts the transmission power P to be increased by changing the phase difference φ to be increased, and thus it is possible to prevent the port voltage Vp from being lower than the aimed port voltage Vo.

<Power Conversion Method for Preventing Reduction in Power Conversion Efficiency and Damages by Through-Current>

The controller 50 is an example of a control portion which adjusts the phase difference φu and the phase difference φv (refer to FIG. 3) so as to control the transmission power P transmitted between the primary full bridge circuit 200 and the secondary full bridge circuit 300.

The phase difference φu is a time difference between switching in the primary first arm circuit 207 and switching in the secondary first arm circuit 307. For example, the phase difference φu is a difference between the turned-on time point t2 of the primary first upper arm U1 and the turned-on time point t1 of the secondary first upper arm U2. The switching in the primary first aim circuit 207 and the switching in the secondary first arm circuit 307 are controlled to be in phase (that is, in U phase) with each other by the controller 50. Similarly, the phase difference φv is a time difference between switching in the primary second arm circuit 211 and the secondary second arm circuit 311. For example, the phase difference φv is a difference between the turned-on time point t6 of the primary second upper arm V1 and the turned-on time point t5 of the secondary second upper arm V2. The switching in the primary second arm circuit 211 and the switching in the secondary second arm circuit 311 are controlled to be in phase (that is, in V phase) with each other by the controller 50.

FIG. 4 is a timing chart illustrating an example of the dead time when neither of the upper arm U1 and the lower /U1 are turned on. The dead time of FIG. 4 is a period of time when both of the upper arm U1 and the lower arm /U1 are turned off, and includes a dead time td1 and a dead time td2. The dead time td1 is a period of time after the lower arm /U1 is turned off until the upper arm U1 is turned on, and the dead time td2 is a period of time after the upper arm U1 is turned off until the lower arm /U1 is turned on. FIG. 4 illustrates the dead time which occurs between the upper arm U1 and the lower arm /U1, but the dead time occurring between other upper and lower arms is also the same as that of FIG. 4, and thus the description related to FIG. 4 is applied by analogy.

The controller 50 shortens the dead time td when neither of the upper arm and the lower arm are turned on in a transmission state St in which the transmission power P is transmitted with a predetermined power value, and detects a gate driving state Sg in which both of the upper arm and the lower arm are turned on. In a case where the gate driving state Sg is detected, the controller 50 sets an adjustment value tda of the dead time td in the transmission state St to a dead time value tdc which is greater than a dead time detection value tdb when the gate driving state Sg is detected.

Therefore, since the adjustment value tda is set to the dead time value tdc greater than the dead time detection value tdb, even if characteristics of each arm formed in the full bridge circuit vary between the respective arms, the adjustment value tda can be changed to an appropriate value (the dead time value tdc). Consequently, it is possible to prevent damages by a through-current which flows when the upper and lower arms are turned on in the same period of time. Since a loss of each full bridge circuit during the power conversion operation is minimized, it is possible to prevent a reduction in power conversion efficiency between the primary full bridge circuit 200 and the secondary full bridge circuit 300.

In FIG. 4, when the controller 50 shortens the dead time td in the transmission state St, for example, both of the dead time td1 and the dead time td2 are gradually shortened. For example, the controller 50 may simultaneously shorten the dead time td1 and the dead time td2, and may alternately shorten the dead time td1 and the dead time td2. In addition, for example, the controller 50 may gradually shorten the dead time td2 in a state in which the dead time td1 is fixed, and may gradually shorten the dead time td1 in a state in which the dead time td2 is fixed.

The dead time td is much shorter than the phase difference φ or the ON time δ (refer to FIG. 3), and thus fluctuations in the phase difference φ and the duty ratio D relative to a change in the dead time td are disregarded.

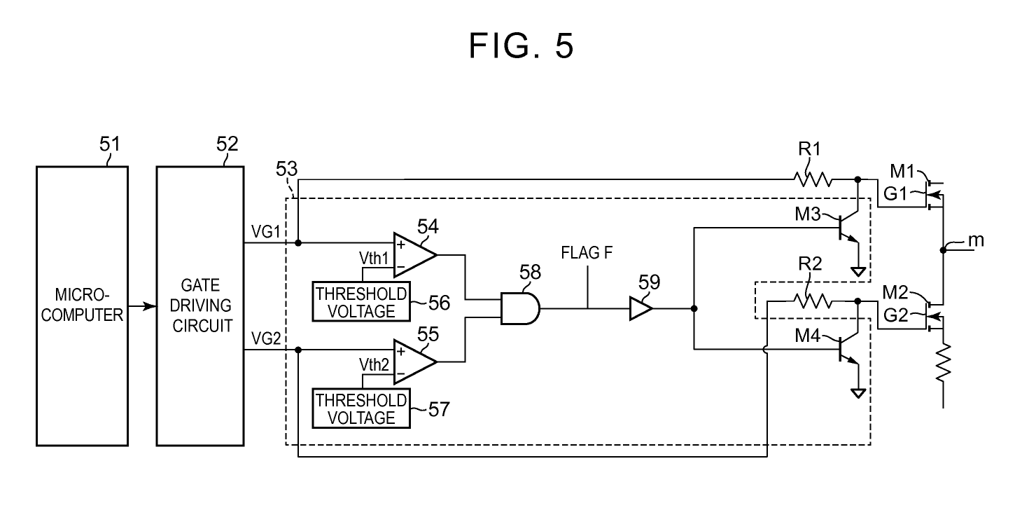

FIG. 5 is a diagram illustrating an example of a configuration of the controller 50. The controller 50 sets the adjustment value tda in the transmission state St in the dead time td when either an upper arm M1 or a lower arm M2 is not turned on. The upper arm M1 corresponds to the upper arm U1 or the like, and the lower arm M2 corresponds to the lower arm /U1 or the like which is connected in series to the upper arm M1 at a midpoint m. The midpoint m corresponds to the midpoint 207m or the like (refer to FIG. 1). In FIG. 5, the controller 50 includes a microcomputer 51, a gate driving circuit 52, and a protection circuit 53.

The microcomputer 51 is an example of a control circuit which outputs a pulse width modulation (PWM) signal for generating the phase difference φ used to change the transmission power P. The gate driving circuit 52 is an example of a driving circuit which outputs a first gate driving signal VG1 for turning on and off the upper arm M1 and a second gate driving signal VG2 for turning on and off the lower arm M2, according to the PWM signal output from the microcomputer 51.

The protection circuit 53 is an example of an interruption circuit which turns off the upper arm M1 and the lower arm M2 when the gate driving state Sg is detected in which both of the upper arm M1 and the lower arm M2 are turned on. The protection circuit 53 has, for example, a circuit which grounds a gate electrode G1 of the upper arm M1 and a gate electrode G2 of the lower arm M2, and thus the upper arm M1 and the lower arm M2 are turned off.

The protection circuit 53 monitors a gate driving state of the upper arm M1 and a gate driving state of the lower arm M2 so as to detect the gate driving state Sg in which both of the upper arm M1 and the lower arm M2 are turned on. For example, the protection circuit 53 compares the gate driving signal VG1 with a threshold voltage Vth1 and compares the gate driving signal VG2 with a threshold voltage Vth2, so as to detect the gate driving state Sg.

The gate driving signal VG1 is an example of a first gate driving signal which is input to the gate electrode G1 of the upper arm M1. In FIG. 5, the gate driving signal VG1 is a signal before being input to a gate resistor R1 connected in series to the gate electrode G1. The gate driving signal VG2 is an example of a second gate driving signal which is input to the gate electrode G2 of the lower arm M2. In FIG. 5, the gate driving signal VG2 is a signal before being input to a gate resistor R2 connected in series to the gate electrode G2.

The threshold voltage Vth1 is a voltage generated by a voltage generation circuit 56 as a voltage value which is the same as a gate threshold voltage which causes the gate electrode G1 of the upper arm M1 to react. The threshold voltage Vth1 is a voltage with respect to a source of the upper arm M1 (with respect to the midpoint m). The threshold voltage Vth2 is a voltage generated by a voltage generation circuit 57 as a voltage value which is the same as a gate threshold voltage which causes the gate electrode G2 of the lower arm M2 to react. The threshold voltage Vth2 is a voltage with respect to a source of the lower arm M2 (with respect to the primary negative bus bar 299 or the secondary negative bus bar 399).

A comparator 54 compares the gate driving signal VG1 with the threshold voltage Vth1, and outputs a high level signal indicating a gate driving state in which the upper arm M1 is turned on, when a voltage of the gate driving signal VG1 is higher than the threshold voltage Vth1. A comparator 55 compares the gate driving signal VG2 with the threshold voltage Vth2, and outputs a high level signal indicating a gate driving state in which the lower arm M2 is turned on, when a voltage of the gate driving signal VG2 is higher than the threshold voltage Vth2. When it is detected that high level signals are output from both of the comparators 54 and 55, an AND gate 58 is a logical product circuit which sets 1 to a flag F by regarding the detection as detection of the gate driving state Sg. The flag F is a signal which is supplied to both a transistor M3 and a transistor M4 via a buffer 59.

When the gate driving state Sg is detected, the protection circuit 53 turns on the transistor M3 which is connected between the gate electrode G1 of the upper arm M1 and the gate resistor R1, by using the flag F, so as to ground the gate electrode G1 via midpoint m, thereby turning off the upper arm M1. Similarly, when the gate driving state Sg is detected, the protection circuit 53 turns on the transistor M4 which is connected between the gate electrode G2 of the lower arm M2 and the gate resistor R2, by using the flag F, so as to ground the gate electrode G2, thereby turning off the lower arm M2.

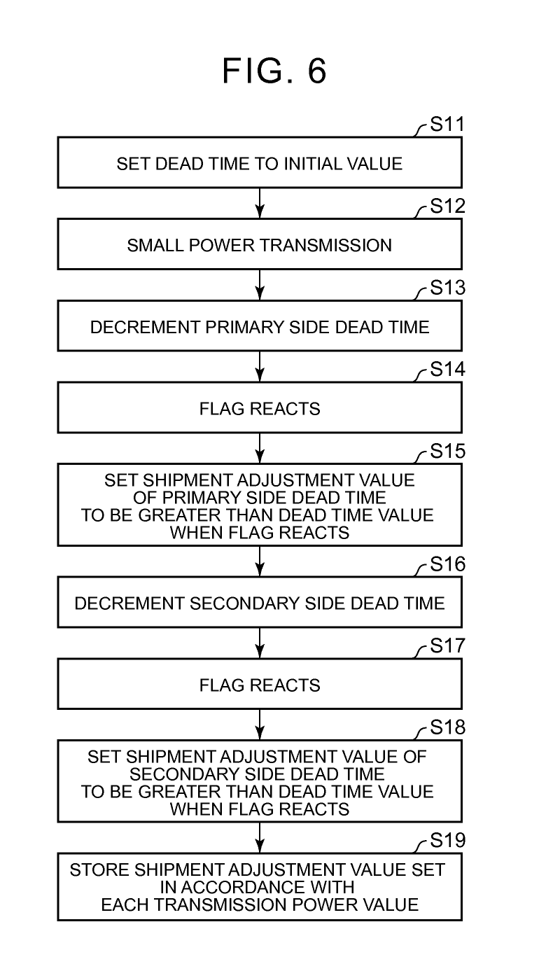

FIG. 6 is a flowchart illustrating an example of a dead time adjustment method performed by the controller 50 during shipment adjustment. The dead time adjustment method illustrated in FIG. 6 is performed, for example, in an inspection step before the power supply circuit 10 is shipped from a manufacturing factory.

In step S11, the controller 50 sets the dead time td to an initial value tda. The initial value tda is a default value. In step S12, the controller 50 turns on and off the upper and lower arms of each of the primary full bridge circuit 200 and the secondary full bridge circuit 300 in the dead time td set to the initial value tda so that the transmission power P is transmitted with a relatively small power value.

In step S13, the controller 50 decrements the dead time td from the initial value tda in the transmission state St in which the transmission power P is transmitted with the power value set in step S12 while monitoring the flag F indicating a gate driving state in relation to the upper arms and the lower arms of the primary full bridge circuit 200.

When it is detected that the flag F reacts in step S14, the controller 50 sets the shipment adjustment value of the dead time td of the primary full bridge circuit 200 in the transmission state St to a dead time value which is longer than a dead time detection value at the time of the reaction of the flag F in step S15. For example, the controller 50 sets the shipment adjustment value of the dead time td of the primary full bridge circuit 200 in the transmission state St to a dead time change value which is obtained by adding a predetermined constant value to the dead time detection value at the time of the reaction of the flag F.

In step S16, the controller 50 decrements the dead time td from the initial value tda in the transmission state St in which the transmission power P is transmitted with the power value set in step S12 while monitoring the flag F indicating a gate driving state in relation to the upper arms and the lower arms of the secondary full bridge circuit 300.

When it is detected that the flag F reacts in step S17, the controller 50 sets the shipment adjustment value of the dead time td of the secondary full bridge circuit 300 in the transmission state St to a dead time value which is longer than a dead time detection value at the time of the reaction of the flag F in step S18. For example, the controller 50 sets the shipment adjustment value of the dead time td of the secondary full bridge circuit 300 in the transmission state St to a dead time change value which is obtained by adding a predetermined constant value to the dead time detection value at the time of the reaction of the flag F.

In step S19, the controller 50 repeatedly performs a series of operations from step S12 to step S18 on each power value of the transmission power P. In other words, the controller 50 sequentially changes the transmission power P from a small power value to a large power value so as to set a shipment adjustment value in each transmission state in which the transmission power P is transmitted with each power value. The controller 50 stores the shipment adjustment value which is set in accordance with each power value of the transmission power P, in a nonvolatile memory as an initial adjustment value of the dead time td. In step S19, the controller 50 stores shipment adjustment values (initial adjustment values) of the dead time td of the two sets of upper and lower arms of the primary full bridge circuit 200, and shipment adjustment values (initial adjustment values) of the dead time td of the two sets of upper and lower arms of the secondary full bridge circuit 300. Hereinafter, the shipment adjustment values (initial adjustment values) of the dead time td of the two sets of upper and lower arms of the primary full bridge circuit 200 are referred to “shipment adjustment values td19a”, and the shipment adjustment values (initial adjustment values) of the dead time td of the two sets of upper and lower arms of the secondary full bridge circuit 300 are referred to as “shipment adjustment values td19b”. Then, the power supply circuit 10 is shipped and mounted in a vehicle.

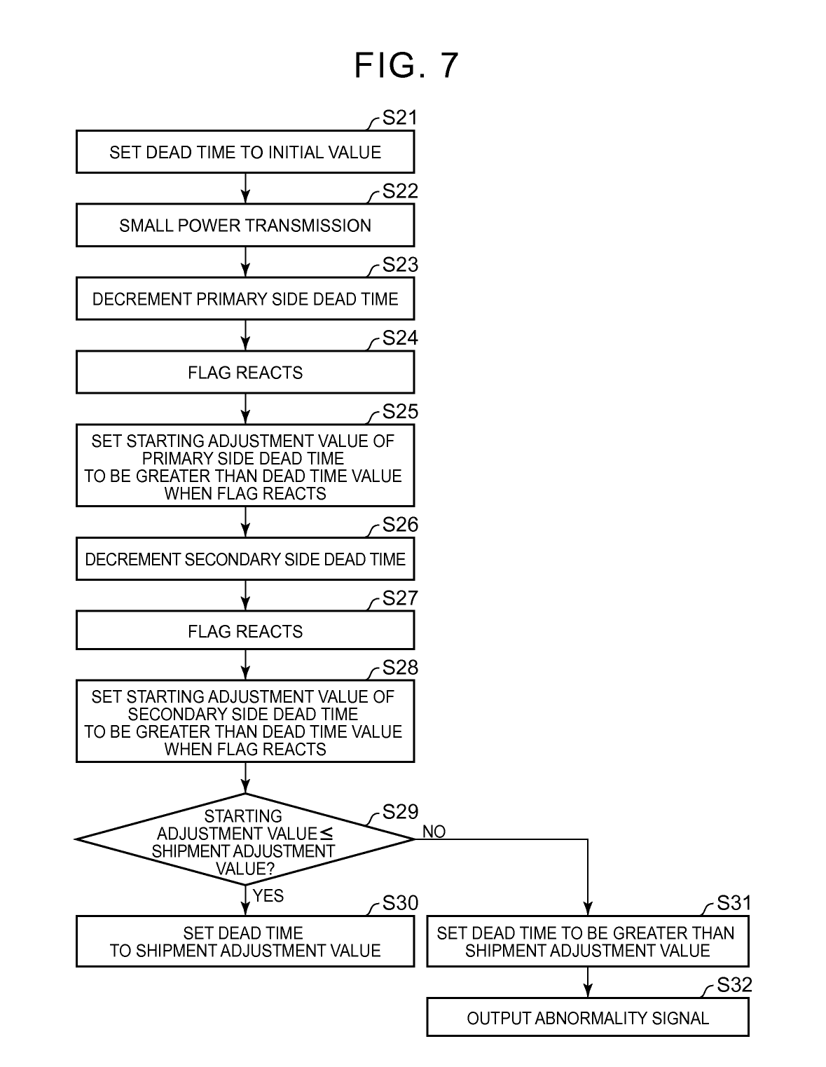

FIG. 7 is a flowchart illustrating an example of a dead time correction method performed by the controller 50 at the time of starting. The time of starting is, for example, the time when an ignition switch is changed from an OFF state to an ON state in order to start an engine of a vehicle.

In step S21, the controller 50 sets the dead time td to an initial value tdb. The initial value tdb is a default value. The initial value tdb may or not the same value as the above-described initial value tda. In step S22, the controller 50 turns on and off the upper and lower arms of each of the primary full bridge circuit 200 and the secondary full bridge circuit 300 in the dead time td set to the initial value tdb so that the transmission power P is transmitted with a relatively small power value.

In step S23, the controller 50 decrements the dead time td from the initial value tdb in the transmission state St in which the transmission power P is transmitted with the power value set in step S22 while monitoring the flag F indicating a gate driving state in relation to the upper arms and the lower arms of the primary full bridge circuit 200. Hereinafter, the transmission state St in which the transmission power P is transmitted with the power value set in step S22 is referred to as a “transmission state St23”.

When it is detected that the flag F reacts in step S24, the controller 50 sets a starting adjustment value of the dead time td of the primary full bridge circuit 200 in the transmission state St23 to a dead time value which is longer than a dead time detection value at the time of the reaction of the flag F in step S25. Hereinafter, the starting adjustment value of the dead time td of the primary full bridge circuit 200 in the transmission state St23 is referred to as a “starting adjustment value td25”. For example, the controller 50 sets the starting adjustment value td25 to a dead time change value which is obtained by adding a predetermined constant value to the dead time detection value at the time of the reaction of the flag F.

In step S26, the controller 50 decrements the dead time td from the initial value tdb in the transmission state St23 while monitoring the flag F indicating a gate driving state in relation to the upper arms and the lower arms of the secondary full bridge circuit 300.

When it is detected that the flag F reacts in step S27, the controller 50 sets a starting adjustment value of the dead time td of the secondary full bridge circuit 300 in the transmission state St23 to a dead time value which is greater than a dead time detection value at the time of the reaction of the flag F in step S28. Hereinafter, the starting adjustment value of the dead time td of the secondary full bridge circuit 300 in the transmission state St23 is referred to as a “starting adjustment value td28”. For example, the controller 50 sets the starting adjustment value td28 to a dead time change value which is obtained by adding a predetermined constant value to the dead time detection value at the time of the reaction of the flag F.

In step S29, the controller 50 compares the starting adjustment value td25 set in step S25 with the shipment adjustment values td19a (that is, the initial adjustment value stored in the nonvolatile memory in step S19 of FIG. 6) in the same transmission state St23 as that of the starting adjustment value td25. Similarly, in step S29, the controller 50 compares the starting adjustment value td28 set in step S28 with the shipment adjustment values td19b (that is, the initial adjustment value stored in the nonvolatile memory in step S19 of FIG. 6) in the same transmission state St23 as that of the starting adjustment value td28.

When the starting adjustment value td25 is the same as the shipment adjustment values td19a in the transmission state St23, in step S30, the controller 50 sets defined adjustment values of the dead time td of the upper and lower arms of the primary full bridge circuit 200 in all the transmission states St, to the shipment adjustment values td19a in the corresponding transmission states, respectively. Hereinafter, the defined adjustment values of the dead time td of the upper and lower arms of the primary full bridge circuit 200 in all the transmission states St are referred to as “defined adjustment values td30a”. Similarly, when the starting adjustment value td28 is the same as the shipment adjustment values td19b in the transmission state St23, in step S30, the controller 50 sets defined adjustment values of the dead time td of the upper and lower arms of the secondary full bridge circuit 300 in all the transmission states St, to the shipment adjustment values td19b in the corresponding transmission states, respectively. Hereinafter, the defined adjustment values of the dead time td of the upper and lower arms of the secondary full bridge circuit 300 in all the transmission states St are referred to as “defined adjustment values td30b”.

In other words, in step S30, if comparison results in one or several transmission states are the same as each other, defined adjustment values in all the transmission states including states in which power is transmitted with other power values are respectively set to the same values as the shipment adjustment values in corresponding transmission states. Since the time which can be used to adjust the dead time td during the starting is restricted, the process as in step S30 is performed, and thus it is possible to reduce the adjustment time of the dead time td during the starting.

The controller 50 applies the defined adjustment values td30a set in step S30 to the dead time td of the upper and lower arms of the primary full bridge circuit 200 and applies the defined adjustment values td30b set in step S30 to the dead time td of the upper and lower arms of the secondary full bridge circuit 300, so as to control switching timings of the upper and lower arms.

The controller 50 may perform the same process as that in step S30 when the starting adjustment value td25 is smaller than the shipment adjustment values td19a in the transmission state St23 in step S29. Similarly, the controller 50 may perform the same process as that in step S30 when the starting adjustment value td28 is smaller than the shipment adjustment values td19b in the transmission state St23 in step S29.

In step S30, the controller 50 may set the defined adjustment values td30a to values greater than the shipment adjustment values td19a in the corresponding transmission states, respectively. Similarly, in step S30, the controller 50 may set the defined adjustment values td30b to values greater than the shipment adjustment values td19b in the corresponding transmission states, respectively.

On the other hand, when the starting adjustment value td25 is greater than the shipment adjustment values td19a in the transmission state St23 in step S29, the controller 50 determines that the dead time td is lengthened due to degradation over time or the like, and performs a process in step S31. Similarly, when the starting adjustment value td28 is greater than the shipment adjustment values td19b in the transmission state St23 in step S29, the controller 50 determines that the dead time td is lengthened due to degradation over time or the like, and performs a process in step S31.

In step S31, the controller 50 sets the defined adjustment values td30a to dead time values which are greater than the shipment adjustment values td19a in corresponding transmission states, respectively. For example, the controller 50 sets the defined adjustment values td30a to dead time change values obtained by adding a predetermined constant value to the shipment adjustment values td19a in the corresponding transmission states. In this case, the dead time change values obtained by adding a predetermined constant value to the shipment adjustment values td19a in the corresponding transmission states are set to values which are shorter than the starting adjustment value td25, and thus it is possible to prevent the defined adjustment values td30a from being set to values greater than necessary.

Similarly, the controller 50 sets the defined adjustment values td30b to dead time values which are greater than the shipment adjustment values td19b in corresponding transmission states, respectively. For example, the controller 50 sets the defined adjustment values td30b to dead time change values obtained by adding a predetermined constant value to the shipment adjustment values td19b in the corresponding transmission states. In this case, the dead time change values obtained by adding a predetermined constant value to the shipment adjustment values td19b in the corresponding transmission states are set to values which are shorter than the starting adjustment value td28, and thus it is possible to prevent the defined adjustment values td30b from being set to values greater than necessary.

In other words, if the starting adjustment values in one or several transmission states are greater than the shipment adjustment values in step S31, defined adjustment values in all the transmission states including states in which power is transmitted with other power values are respectively set to values obtained by uniformly adding a predetermined constant value to the shipment adjustment values in corresponding transmission states. Since the time which can be used to adjust the dead time td during the starting is restricted, the process as in step S31 is performed, and thus it is possible to reduce the adjustment time of the dead time td during the starting.

The controller 50 applies the defined adjustment values td30a set in step S31 to the dead time td of the upper and lower arms of the primary full bridge circuit 200 and applies the defined adjustment values td30b set in step S31 to the dead time td of the upper and lower arms of the secondary full bridge circuit 300, so as to control switching timings of the upper and lower arms.

In step S32, the controller 50 outputs an abnormality signal indicating that the defined adjustment values are set to dead time values greater than the shipment adjustment values. The abnormality signal may be an alarm signal of which a notification is sent to an occupant, and may be failure information (diagnostic information) which is input to and stored in a memory. Since the abnormality signal is output, the dead time td can be prompted to be readjusted during examination in a repair shop or the like. The readjustment of the dead time td in this case is performed, for example, by rewriting the shipment adjustment values stored in the nonvolatile memory.

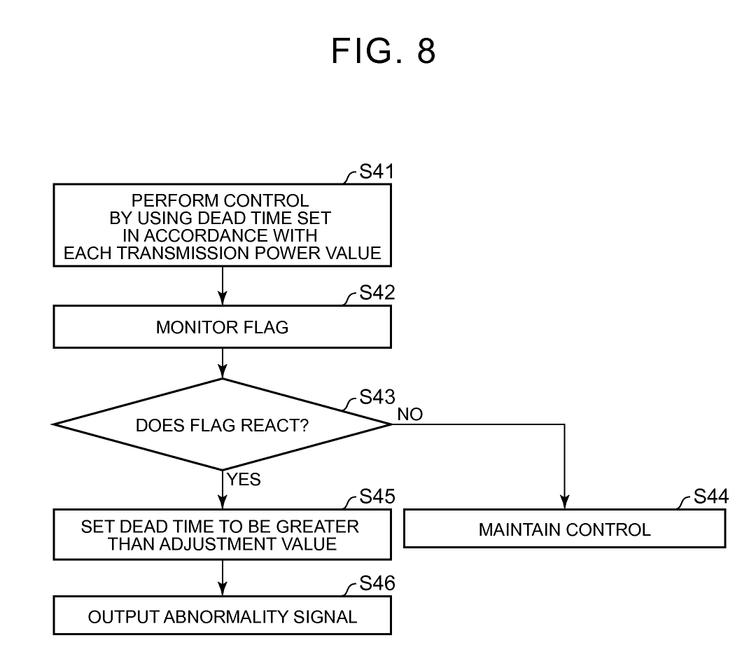

FIG. 8 is a flowchart illustrating an example of a dead time correction method performed by the controller 50 during a normal operation. A period of time of the normal operation is a period of time, for example, after starting due to an ON state of the ignition switch until the ignition switch enters an OFF state.

In step S41, the controller 50 controls switching of the upper and lower arms by using the defined adjustment values td30a and td30b which are set in accordance with the respective power values of the transmission power P. In a case where the transmission power P is transmitted with a power value for which the defined adjustment values td30a and td30b are not set, the controller 50 may control switching of the upper and lower arms by using a value obtained by interpolating the defined adjustment values td30a and 30b. In step S42, the controller 50 monitors the flag F in the control state of step S41.

If the flag F does not react in the control state of step S41 in step S43, the controller 50 maintains the control state of step S41 in step S44. In other words, the controller 50 continuously controls switching of the upper and lower arms by using the defined adjustment values td30a and td30b which are set in accordance with the respective power values of the transmission power P.

On the other hand, if the flag F reacts in the control state of step S41 in step S43, the controller 50 continuously controls switching of the upper and lower arms by using values greater than the defined adjustment values td30a and td30b in step S45. For example, the controller 50 continuously controls switching of the upper and lower arms by using values obtained by adding a predetermined constant value to the defined adjustment values td30a and td30b.

If the flag F reacts in the control state of step S41, the controller 50 determines that the dead time td is lengthened due to degradation over time, a temperature change, or the like, and turns off the all the upper and lower arms by using the protection circuit 53 of FIG. 5. The controller 50 continuously controls switching of the upper and lower arms by using values greater than the defined adjustment values td30a and td30b at switching timings (for example, turning-on or turning-off timings) after the upper and lower arms are turned off by the protection circuit 53.

The controller 50 increases the defined adjustment values td30a and td30b of the switching timings in the next and subsequent switching cycles after the upper and lower arms are turned off. Although power transmission is temporarily stopped in the switching cycle in which the flag F reacts, a switching frequency is relatively high as several tens of kHz, and thus necessary power in the switching cycle in which the flag F reacts can be supplied by using the capacitors or the like. The controller 50 can continuously control switching of the upper and lower arms by using values greater than the defined adjustment values td30a and td30b in the next and subsequent switching cycles.

In step S46, the controller 50 outputs an abnormality signal indicating that the defined adjustment values td30a and td30b are increased. The abnormality signal may be an alarm signal of which a notification is sent to an occupant, and may be failure information (diagnostic information) which is input to and stored in a memory. Since the abnormality signal is output, the dead time td can be prompted to be readjusted during examination in a repair shop or the like. The readjustment of the dead time td in this case is performed, for example, by rewriting the shipment adjustment values stored in the nonvolatile memory.

As mentioned above, although the power conversion device and the power conversion method have been described by means of the embodiment, the invention is not limited to the embodiment. Various modifications and alterations such as combinations or replacements of some or all other embodiments may occur in the scope of the invention.

For example, in the above-described embodiment, the MOSFET which is a semiconductor element performing turning-on and turning-off operations has been described as an example of the switching element. However, the switching element may be a voltage controlled power element using an insulating gate, such as an IGBT or a MOSFET, and may be a bipolar transistor.

The power supply may be connected to the first input/output port 60a, and may be connected to the fourth input/output port 60d. In addition, the power supply may not be connected to the second input/output port 60c, and may not be connected to the third input/output port 60b.

In FIG. 1, the primary low voltage system power supply 62c is connected to the second input/output port 60c, but may not be connected to either the first input/output port 60a or the second input/output port 60c.

The invention is applicable to a power conversion device which has a plurality of (three or more) input/output ports and can convert power between arbitrary two input/output ports among the plurality of (three or more) input/output ports. For example, the invention is applicable to a power supply device having a configuration in which any one of the four input/output ports exemplified in FIG. 1 is omitted.

In the above description, the primary side may be defined as a secondary side, and the secondary side may be defined as a primary side. In the above description, a case has been described in which the transmission power P is transmitted from the secondary port to the primary port, but the above description is applicable to a case where the transmission power P is transmitted from the primary port to the secondary port.

For example, the controller 50 may correct an adjustment value of the dead time td according to a temperature change. Consequently, it is possible to reduce the number of times of correction of the dead time td during a normal operation.

What is claimed is:

1. A power conversion device comprising:
a primary full bridge circuit;
a secondary full bridge circuit; and
a control portion configured to adjust a phase difference between switching in the primary full bridge circuit and switching in the secondary full bridge circuit, so as to control transmission power transmitted between the primary full bridge circuit and the secondary full bridge circuit, wherein
each of the primary full bridge circuit and the secondary full bridge circuit includes an upper arm and a lower aim connected in series to the upper arm,
the control portion shortens a dead time when neither of the upper arm and the lower arm are turned on in a transmission state in which the transmission power is transmitted with a predetermined power value, and
in a case where a gate driving state is detected in which both of the upper arm and the lower arm are turned on, the control portion sets an adjustment value of the dead time in the transmission state to a dead time value which is greater than a dead time detection value when the gate driving state is detected.

2. The power conversion device according to claim 1, wherein
in a case where a dead time change value obtained by adding a predetermined value to the dead time detection value when the gate driving state is detected is greater than a reference value, the control portion sets the adjustment value to be greater than the reference value.

3. The power conversion device according to claim 2, wherein
the control portion sets the adjustment value to be greater than the reference value, and sets the adjustment value to be smaller than the dead time change value.

4. The power conversion device according to claim 2, wherein
the control portion outputs an abnormality signal when the set value is greater than the reference value.

5. The power conversion device according to claim 1, wherein
in a case where a dead time change value obtained by adding a predetermined value to the dead time detection value when the gate driving state is detected is equal to or smaller than a reference value, the control portion sets the adjustment value to the reference value or a value greater than the reference value.

6. The power conversion device according to claim 2, wherein
the reference value is an initial adjustment value of the dead time.

7. The power conversion device according to claim 1, wherein
the control portion sets the adjustment value for each power value of the transmission power.

8. The power conversion device according to claim 1, wherein
in a case where the gate driving state is detected, the control portion sets an adjustment value of the dead time in a transmission state in which the transmission power is transmitted with a power value different from the predetermined power value, to be greater than a dead time detection value when the gate driving state is detected.

9. The power conversion device according to claim 1, wherein
the control portion increases the adjustment value when the gate driving state is detected in a control state in which switching of the upper arm and the lower arm is controlled by using the adjustment value.

10. The power conversion device according to claim 9, wherein
when the gate driving state is detected in the control state, the control portion turns off the upper arm and the lower arm, and
the control portion increases the adjustment value at a switching timing after the upper arm and the lower arm are turned off.

11. The power conversion device according to claim 9, wherein
the control portion outputs an abnormality signal when the adjustment value is increased in the control state.

12. The power conversion device according to claim 1, wherein
the control portion turns off the upper arm and the lower arm when the gate driving state is detected.

13. The power conversion device according to claim 12, wherein
the control portion grounds a gate electrode of the upper arm and a gate electrode of the lower arm, so as to turn off the upper arm and the lower arm.

14. The power conversion device according to claim 1, wherein
the control portion compares a first gate driving signal input to a gate electrode of the upper arm with a gate threshold value of the upper arm, and compares a second gate driving signal input to a gate electrode of the lower arm with a gate threshold value of the lower arm, so as to detect the gate driving state.

15. A power conversion method for a power conversion device which includes a primary full bridge circuit and a secondary full bridge circuit, each of the primary full bridge circuit and the secondary full bridge circuit including an upper aim and a lower arm connected in series to the upper arm, the method comprising:
adjusting a phase difference between switching in the primary full bridge circuit and switching in the secondary full bridge circuit, so as to control transmission power transmitted between the primary full bridge circuit and the secondary full bridge circuit;
shortening a dead time when neither of the upper arm and the lower arm are turned on in a transmission state in which the transmission power is transmitted with a predetermined power value; and
setting an adjustment value of the dead time in the transmission state to a dead time value which is greater than a dead time detection value when a gate driving state is detected in a case where the gate driving state is detected in which both of the upper arm and the lower arm are turned on.
